(19) United States
(12) Patent Application Publication
(10) Pub. No.: US 2004/0156066 A1
(43) Pub. Date: Aug. 12, 2004

(54) Document processing apparatus and document processing method

(75) Inventors: Kimie Mishima, Itami-shi (JP); Yoshiyuki Tamai, Itami-shi (JP); Masami Yamada, Sennan-gun (JP); Yoshiki Tokimoto, Nishiwaki-shi (JP)

Correspondence Address: MORRISON & FOERSTER LLP, 1650 TYSONS BOULEVARD, SUITE 300, MCLEAN, VA, 22102, US

(73) Assignee: Minolta Company, Ltd., Osaka (JP)

(21) Appl. No.: 10/641,153

(22) Filed: Aug. 15, 2003

(30) Foreign Application Priority Data
Jan. 27, 2003 (JP) 2003-17406

(51) Int. Cl. G06K 15/02; G06F 3/12; G06F 15/00

(52) U.S. Cl. 358/1.13; 358/1.15; 358/1.18

(57) ABSTRACT

A document processing apparatus capable of easily performing various processing for a document in a box and lightening a burden of a user is provided. A user sets contents of document processing for changing the document contents of a document in the box in advance. When prescribed execution conditions (executing timing) are met, the document processing for the document in the box is executed automatically. Furthermore, the user sets a print mode depending on the status of the document in the box in advance. Depending on the timing of receiving the print instruction, the print mode is changed automatically to execute the print processing.

Priority is claimed to Japanese Patent Application No. 2003-17406, filed on Jan. 27, 2003, the disclosure of which is incorporated by reference in its entirety.

### BACKGROUND OF THE INVENTION

1. Field of the Invention

The present invention relates to a document processing apparatus equipped with a box for storing a document, and particularly, to a document processing apparatus or the like having a box processing function for executing prescribed document processing for a document stored in the box.

2. Description of Related Art

The following description sets forth the inventor's knowledge of related art and problems therein and should not be construed as an admission of knowledge in the prior art.

In a conventional document processing apparatus, such as a printer, a facsimile machine and a multifunction peripheral, connected to a network, a document processing apparatus having a box function for storing obtained documents is known.

For example, Japanese Unexamined Laid-open Patent Publication No. 10-145493 discloses a message storing/exchanging apparatus in which a storing area for storing a program automatically executing immediately before and after a registration of a message and immediately before and after the reading of the message is provided in each box and a message processing procedure executing apparatus executes the program at each timing. As the automatically executing processing, exemplified are the processing for erasing the message stored in the box before the next message is stored, the processing for transmitting a message arrival notice to a facsimile of the box owner after a message is stored in the box, the processing for sending out a notice from the administrator of the apparatus if any before a message is retrieved from the box and the processing for sending a retrieve notice to the sender of the retrieved message after the message is retrieved from the box.

Furthermore, Japanese Unexamined Laid-open Patent Application No. 2002-185752 discloses a communication terminal device. In the communication terminal device, distribution tables in which selection conditions correlating the received data property (e.g., caller number, incoming dial-in, incoming line) with a specific data box are provided every property information. Also provided are priority tables each defining the order of priority of the distribution tables of each property information. In accordance with the order based on the priority tables, the distribution tables are referred to compare the property information of the received data with the property information stored the distribution tables. Then, the received data is stored in the data box corresponding to the coincident property information.

Furthermore, Japanese Unexamined Laid-open Patent Publication No. 2001-197319 discloses an image forming apparatus. In this image forming apparatus, upon receiving data existence/nonexistence query signals from an external information processing apparatus, it is discriminated whether the specified confidential box includes image data, and the report is formed and then transmitted to the external information processing apparatus. On the other hand, upon receiving data transmission request signals from the external information processing apparatus, it is discriminated whether the specified confidential box includes image data. If it is discriminated that it includes image data, the image data is read out from the specified confidential box and then transmitted to the external information processing apparatus.

In the meantime, in cases where a work using a document stored in a box advances, even if the document is once stored in the box, a user may wish to change the document contents.

According to a conventional box function, however, in order to change the document contents of the document in the box, the user is required to retrieve the document from the box and then change it manually.

Furthermore, in cases where a work using the document stored in the box advances, the purpose for printing out the document stored in the box may change.

According to the conventional box function, however, in order to set the print mode of the document stored in the box, the user is required to set the print mode manually in accordance with the print out timing.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

In view of the aforementioned problems, it is an object of the present invention to provide a document (image) processing apparatus capable of easily executing various processing for a document in a box and reducing a user's burden.

According to one aspect of the present invention, a document processing apparatus includes a box capable of storing a document, a processing contents input unit to receive contents of document processing for changing document contents of the document stored in the box, a processing contents storage unit to store the contents of the document processing, the processing contents storage unit being provided within or outside the box, and a document contents change processing unit to execute the document processing for changing the document contents of the document stored in the box based on the contents of the document processing when prescribed execution conditions to execute the document processing are met.

Another objects and/or characteristics of the present invention will be apparent from the following explanations with reference to the attached drawings.

The above and/or other aspects, features and/or advantages of various embodiments will be further appreciated in view of the following description in conjunction with the accompanying drawings. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The accompanying drawings are provided by way of example, without limiting the broad scope of the invention or various other embodiments, wherein:

FIG. 1 is a schematic view showing an entire structure of a document processing system including a document processing apparatus according to an embodiment of the present invention;

FIG. 2A is a schematic explanatory view showing the structure of the box in the document processing apparatus;

FIG. 2B is an explanatory table showing one example of processing information;

FIG. 2C is an explanatory table showing one example of print mode information;

FIG. 3 is an explanatory view showing one example of a flow of work performed by using documents in the box;

FIG. 4 is an explanatory view showing one example of document processing accompanied by modifications of document contents performed when the storing of all the documents is completed;

FIG. 5 is an explanatory view showing one example of document processing accompanied by modifications of document contents performed when an approval of the documents is returned;

FIG. 6 is an explanatory view showing examples of print modes set depending on the stage of the document processing;

FIG. 7A is an explanatory view showing one example of an operation panel screen for selecting a box to which a function is to be added at the time of setting a document processing function in the box;

FIG. 7B is an explanatory view showing one example of an operation panel screen for inputting characters to specify the document to be stored at the time of setting a document processing function in the box;

FIG. 7C is an explanatory view showing one example of an operation panel screen for inputting the sender to specify the document to be stored at the time of setting a document processing function in the box;

FIG. 8A is an explanatory view showing one example of an operation panel screen for selecting the matter of the documents to be changed at the time of setting a document processing function in the box;

FIG. 8B is an explanatory view showing one example of an operation panel screen for selecting the timing for executing the document processing accompanied by a change of the document contents at the time of setting a document processing function in the box;

FIG. 8C is an explanatory view showing one example of an operation panel screen for selecting subsequent processing after the setting of the document processing accompanied by a change of the document contents at the time of setting a document processing function in the box;

FIG. 8D is an explanatory view showing one example of an operation panel screen for inputting the destination of documents at the time of setting the document processing function in the box;

FIG. 9A is an explanatory view showing one example of an operation panel screen for setting a print mode to be applied after the document processing accompanied by the change of the document contents at the time of setting the print mode corresponding to the stage of the document processing;

FIG. 9B is an explanatory view showing one example of an operation panel screen for setting a color mode among print modes at the time of setting the print mode corresponding to the stage of the document processing;

FIG. 9C is an explanatory view showing one example of an operation panel screen for setting a page setting among print modes at the time of setting the print mode corresponding to the stage of the document processing;

FIG. 10 is a flowchart showing an example of processing procedures when documents are received;

FIG. 11 is a flowchart showing an example of processing procedures when the document storing is completed;

FIG. 12 is a flowchart showing an example of processing procedures accompanied by changes of the document contents to be executed when the document storing is completed;

FIG. 13 is a flowchart showing an example of processing procedures to be executed when the document are returned;

FIG. 14 is a flowchart showing an example of document processing procedures accompanied by changes of the document contents to be executed when an approval of the document is returned; and

FIG. 15 is a flowchart showing an example of processing procedures when a print instruction is received.

### DETAILED DESCRIPTION OF THE PREFERRED EMBODIMENTS

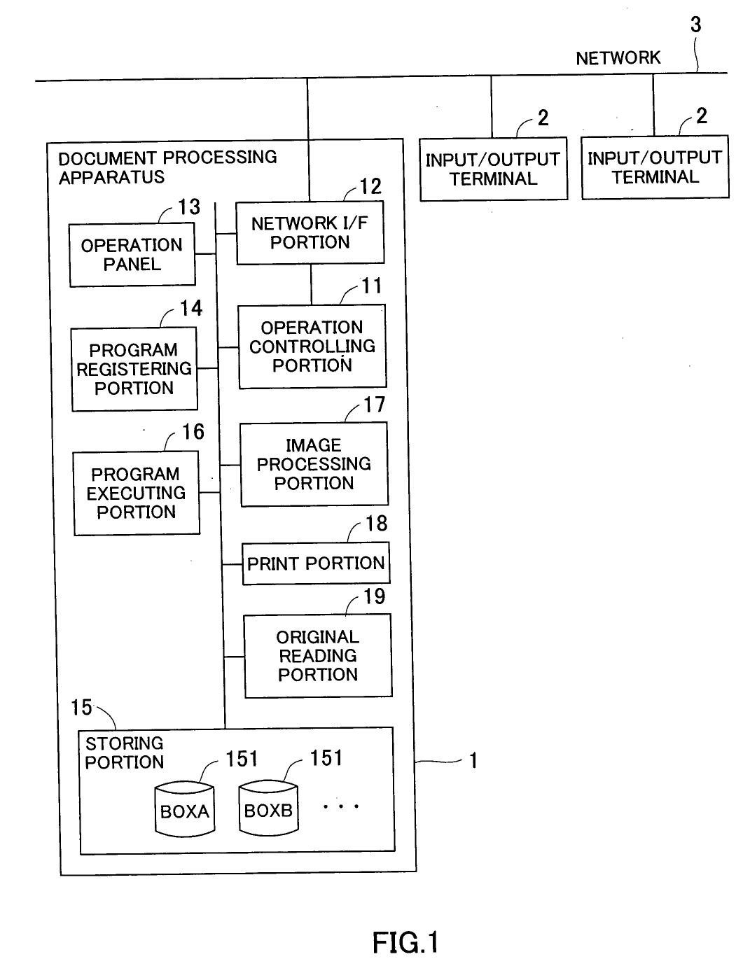

A preferred embodiment of the present invention will be explained with reference to FIGS. 1 to 15.

The document processing apparatus 1 is the so-called multi function peripheral having various functions such as a printer function, a scanner function, a copy function and a facsimile function.

FIG. 1 is a schematic view showing an entire structure of a document processing system including the document processing apparatus 1 according to the embodiment of the present invention. As shown in FIG. 1, this document processing apparatus 1 is connected to a plurality of input/output terminals 2 such as personal computers via a network 3 such as a LAN to exchange various information with each input/output terminal 2. The document processing apparatus 1 constitutes a document processing system together with the input/output terminals 2 and the network 3.

The document processing apparatus 1 is provided with a micro computer including CPUs, RAMs and ROMs. Functionally, the document processing apparatus 1 is equipped with an operation controlling portion 11 which controls the entire apparatus, a network interface (I/F) portion 12 for connecting the apparatus to the network 3, an operation panel 13 for receiving various inputs from users, a program registering portion 14 for executing program registration processing of various document processing programs, a program executing portion 16 for executing various document processing programs, a storing portion 15 having a plurality of boxes 151, an image processing portion 17 for executing changing processing of document contents among the document processing, a print portion 18 for executing print processing of documents and an original reading portion 19 for reading originals. Hereinafter, each portion will be explained.

(Operation Controlling Portion)

The operation controlling portion 11 organically controls each operation of this document processing apparatus 1.

This operation controlling portion 11 is constituted on a microcomputer including CPUs, RAMs and ROMs.

(Network Interface Portion)

The network interface portion 12 is configured to connect the apparatus 1 to the network 3 in order to send/receive various information to/from input/output terminals (personal computers) 2. One example of this network interface portion 12 is a network card.

(Operation Panel)

The operation panel 13 functions as an input means to receive various input from users, and is constituted by a touch panel and/or push buttons.

This operation panel 13 functions as a processing contents input means to receive inputs of contents of various document processing executing for documents in the boxes 151 from users. The aforementioned document processing includes, for example, document transfer (forward) processing for transferring (forwarding) a document in the box 151 to a previously set destination, notification processing for notifying a previously set destination the fact that a document is registered in the box 151, combination-and-print processing for combining a plurality of documents in the box 151 and then printing the combined document and document contents change processing for changing contents of the document in the box 151. As will be explained later, these document processing will be executed when the respective execution conditions are met.

The operation panel 13 functions as a print instruction input means for receiving inputs of a print instruction for a document in the box 151 from a user.

Furthermore, the operation panel 13 functions as a print mode input means for receiving a print mode setting contents from a user in cases where a print mode at the time of printing out the document in the box 151 is set depending on the stage of the document processing of the document (the status of the document) in the box 151 in advance.

(Program Registering Portion)

The program registration portion 14 registers program codes for various document processing for documents in the boxes 151. Furthermore, in cases where print modes at the time of printing out the documents in the boxes 151 are set in advance, the aforementioned program registration portion 14 also executes registration processing which converts the print mode into a data type print mode capable of referring the document processing program executing the print mode setting processing (changing processing) and then registering the print mode in each box 151.

The program registering portion 14 is constituted by a microcomputer including CPUs, RAMs, ROMs, etc.

In this embodiment, the contents of the document processing as mentioned above are inputted by a user via the operation panel 13. The program registering portion 14 creates program codes to execute the contents of the document processing inputted by the user. In other words, the program registering portion 14 has a function as a program code creating means.

(Storing Portion)

The storing portion 15 is comprised of a storing apparatus such as a hard disc, a rewritable DVD apparatus and a flush memory, and has a plurality of boxes 151 capable of registering documents obtained by this document processing apparatus 1.

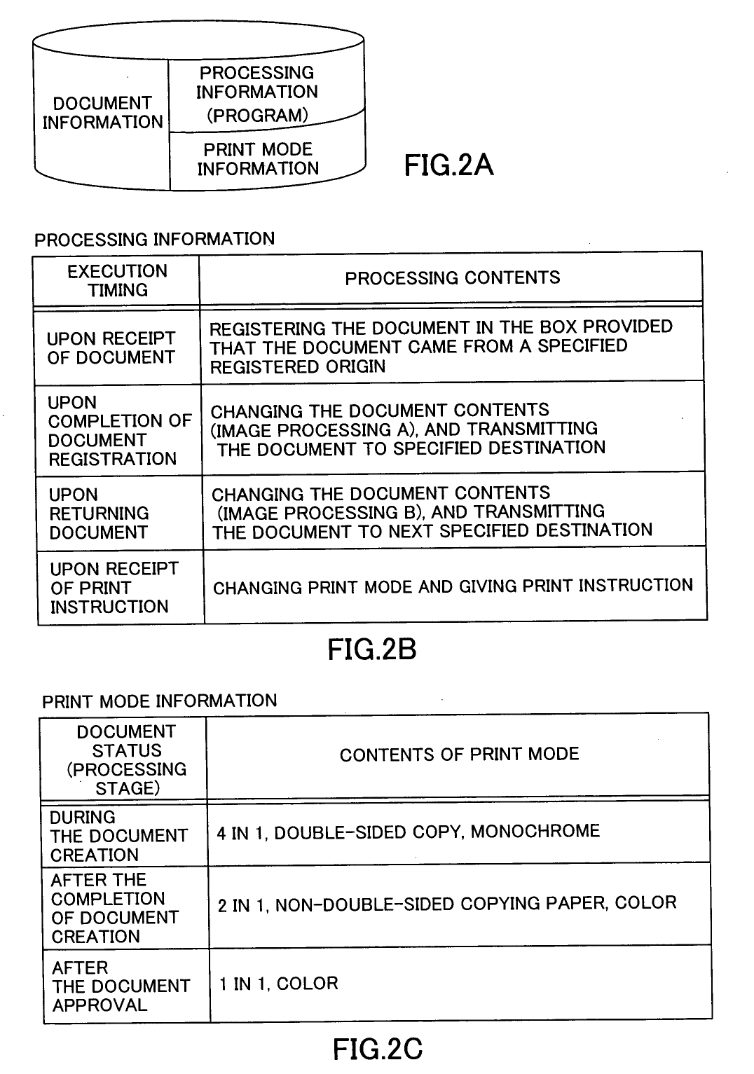

FIG. 2 is a schematic explanatory view showing the box 151. FIG. 2A is a structural view of the box. As shown in FIG. 2A, each box 151 is configured to store document information (image information), processing information(program) and print mode information.

<Document Information>

The document information includes document data or image data in a prescribed data format, and is treated as an electronic file. Each box 151 is configured to store one or a plurality of document information. Each document information includes a document body, such as document data or image data, to be printed out. The document information also includes file administrative information, such as file creation date and time (file saved date and time), file creator, file type and file property, and document format information concerning a document style, such as font type, page number, line number per page, word number per line, header and footer. Document administrative information, such as document creation date, document file name, issue department, approval column and document number, can be included in a document body, such as document data or image data, to be printed out.

<Processing Information>

The aforementioned processing information is information showing the contents of various document processing for the documents in the box 151. In this embodiment, each box for storing document information is configured to store the processing information, whereby the box also functions as a processing contents storing portion. That is, in this embodiment, processing contents storing means is provided in each box 151.

Concretely, the processing information is a program (program code) created by the aforementioned program registering portion 14 to execute the contents of the document processing, and is registered by the program registering portion 14. In each box, one or a plurality of processing information can be set.

This processing information includes execution conditions (execution timing) and concrete processing contents associated with each other. The aforementioned execution conditions denote program start conditions for executing concrete processing contents of the program.

As the execution conditions, for example, the following conditions can be set: when a document is received from a previously specified sender; when a plurality of documents previously set are stored in the box; when changing of document contents of the document in the box is completed, or when a previously set time has passed.

As the processing contents, for example, the following processing as previously mentioned can be set: document transfer (forward) processing for transferring (forwarding) the document in the box 151 to a previously set destination; notification processing for notifying a previously set destination that the document is stored in the box 151; combination-and-print processing for combining a plurality of documents in the box 151 and then printing the combined document; and document contents change processing for changing contents of the document in the box 151.

In the document contents change processing, document administrative information, such as document creation date, file name, issue department, approval column and document number contained in a document body of document data or image data to be printed out, can be changed. Furthermore, file administrative information, such as file creation date (file saving date), file creator, file type and file property, can also be changed. In addition to the above, document style information regarding such document style as font type, page number, line number per page, word number per line, header or footer, can be changed.

FIG. 2B is an explanatory view showing one example of the processing information. In FIG. 2B, the processing information is expressed by natural language for the explanation purpose. However, in reality, programming language is employed. For example, the processing information entitled “upon receipt of document” as the execution timing indicates that the concrete document processing of “registering the document in the box provided that the document came from a specified registered origin” is executed when the execution condition that the box received the document are met. These processing information are to be set in cases where concrete operations using documents in the box 151, which will be detailed, are executed. The concrete contents will be detailed later.

<Print Mode Information>

The print mode information is information showing print modes to be applied at the time of printing the document stored in the box. In this print mode information, different print modes can be set depending on each stage (document status) of the document processing for the document stored in the box 151. In this embodiment, each box 151 configured to store document information also stores print mode information, and therefore it also functions as a print mode storing means. In other words, in this embodiment, the print mode storing means is provided within each box 151. Concretely, the print mode information is inputted via the operation panel 13 by a user, and then the information is converted by the program registering portion 14 in data format and registered.

This print mode information includes stages of document processing (document status) and concrete print modes correlated with each other.

The aforementioned stages of document processing correspond to the stage of the aforementioned document processing at which the document in the box has been executed, and indicate the status of the document in the box 151 or the situation of the document in the box 151. Concrete examples of the stages of document processing include “During the document creation” which means that the document is being created in the box 151, “After the completion of document creation” which means that the document in the box 151 has been created, and “After the document approval” which means that the created document has been approved by a predetermined approving person.

The contents of print mode can be any contents that can be set by a user at the time of executing a normal print. Concrete examples of print mode include a mode for specifying paper type, paper size, layout, color mode, double-sided print or one-side print and a mode for specifying paper feed source. The aforementioned paper type denotes a type of paper discriminated by characteristics of paper, such as normal paper, recycled paper, high-quality paper, non-double-sided print paper and OHP film. The aforementioned layout denotes the number of originals, the arranging order of originals and/or the position of originals to be printed on a single paper. In this specification, in a case where “N” sheets of originals are arranged on a single outputting paper, it will be referred to as “N in 1.” For example, in a case where 4 sheets of originals are arranged on a single outputting paper, it will be referred to as “4 in 1.” In the aforementioned color mode, a discrimination of color, such as color or monochrome, resolution or the number of colors, can be set. In the aforementioned mode for specifying paper feed source, one of paper feed sources (paper feed cassettes) can be specified in cases where there are a plurality of paper feed cassettes.

FIG. 2C is an explanatory view showing one example of print mode information. In this example, if there is a print instruction “during the document creation,” printing is performed at the print mode of “4 in 1, double-sided copying, monochrome.” If there is a print instruction “after the completion of document creation,” printing is performed at the print mode of “2 in 1, non-double-sided copying paper, color.” If there is a print instruction “after the document approval,” printing is performed at the print mode of “1 in 1, color.” The setting of print modes other than the mode specified herein can be the same setting as set immediately before or the default setting.

(Program Executing Portion)

The program executing portion 16 executes various document processing for documents in the boxes 151 by executing the processing information (program code) stored in each box 151 of the storing portion 15. That is, the program executing portion 16 functions as a document processing means.

This program executing portion 16 is constituted on a microcomputer including CPUs, RAMs, ROMs, etc.

In cases of document processing accompanied by document contents changes, the program executing portion 16 calls up an image processing portion 17 which will be mentioned later and assigns the image processing portion 17 to the document processing. In other words, the program execution portion 16 functions as a document contents change processing means together with the image processing portion 17.

Furthermore, when the document processing apparatus 1 receives a print instruction from a user, the program execution portion 16 sends a print mode change instruction in accordance with the print mode information stored in each box 151. In other words, the program execution portion 16 functions as a print mode controlling means together with a print portion 18.

(Image Processing Portion)

The image processing portion 17 executes processing accompanied by document contents changes among document processing to be executed for documents in the boxes 151.

This image processing portion 17 is constituted by a microcomputer including CPUs, RAMs, ROMs, etc.

This image processing portion 17 executes document processing (image processing) for changing document contents of documents in the boxes 151 by executing the processing information (program code) stored in each box 151 of the storing portion 15. That is, the image processing portion 17 functions as a document contents change processing means.

As the document processing (image processing) for changing the document contents, as mentioned above, modification of the document creation date included in the document data can be exemplified.

(Print Portion)

The print portion 18 is used to print out documents on output papers or the like, and can be, for example, an electrophotographic type printer. The documents to be printed out include a document transmitted to the document processing apparatus 1 together with the print instruction and documents stored in the box 151. When the print portion receives the print mode change instruction from the program executing portion 16, the print portion 18 changes the print mode in accordance with the print mode information stored in each box 151 and executes the print out processing. That is, the print portion 18 functions as a print mode controlling means.

(Original Reading Portion)

The original reading portion 19 reads the image of the original as electric data, and can be, for example, a scanner.

### EXAMPLE

Hereinafter, a concrete operation using the document in the box 151 will be exemplified, and the various setting and processing flows thereof will be explained.

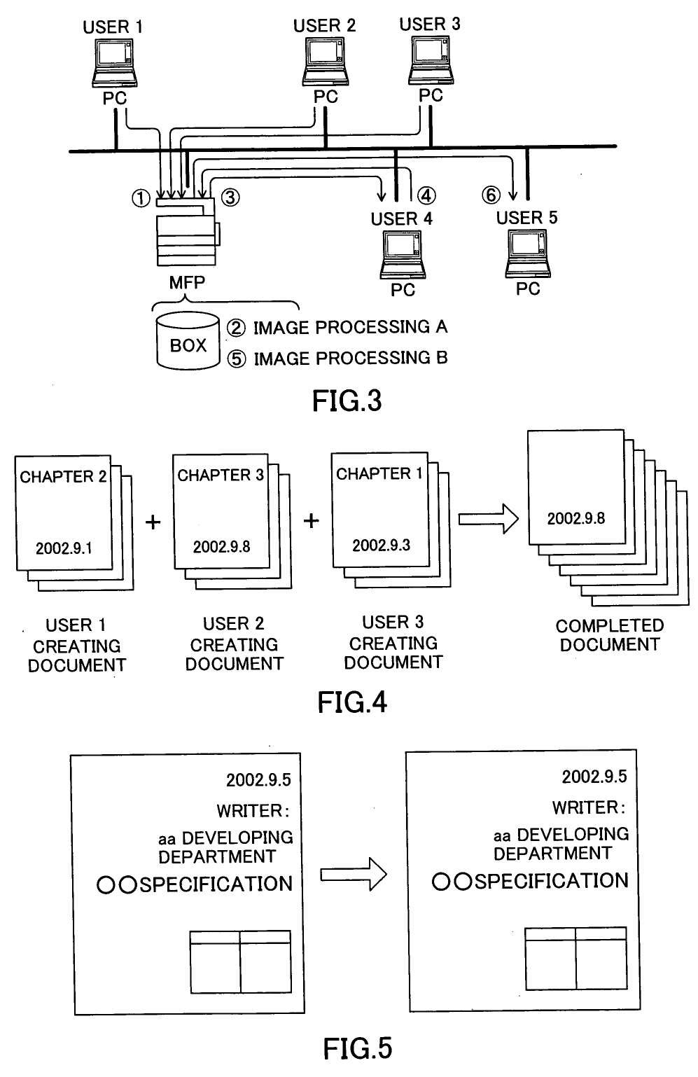

FIG. 3 is an explanatory view showing an example of operational flow. In this example, the following sequence of operations is assumed. That is, three users (User 1, User 2 and User 3) create a document by taking charge of the respective part thereof, and then the contents of the completed document is approved by the fourth user 4 (User 4). After the approval, the approved document is forwarded to the fifth user (User 5). In order to easily perform the sequence of operations, the box 151 of the document processing apparatus 1 is utilized. Concrete document processing related to the box 151 will be explained as follows.

(1) Storing Documents by User 1 to User 3

Each part of a document created by each of users 1 to 3 is stored in a specified box 151 in the document processing apparatus 1 from respective input/output terminals (personal computers: PC) 2.

(2) Document Processing (Image Processing A)

When the respective portions of the document prepared by the users 1 to 3 are gathered in the box 151, document processing for the document accompanied by document contents changes is performed to thereby complete the document. In this embodiment shown in FIG. 4, the following document processing (image processing A) will be executed. The respective portions of the document prepared by the respective users 1 to 3 are arranged in the order of the chapter number contained therein, and further the respective document creation dates are changed into the actual date when the document creation is completed.

(3) Transmitting to the User 4

The completed document will be transmitted (forwarded) to the input/output terminal (personal computer: PC) 2 of the User 4 from the box 151.

(4) Retuning from the User 4

When the contents of the completed document is approved by the User 4, the document is returned to the box 151.

(5) Document Processing (Image Processing B)

For the document in the box 151 returned from the User 4, document processing for changing the document contents will be executed. In this processing, the fact that the document is approved by the User 4 will be added to the document. In this embodiment, as shown in FIG. 5, the following document processing (image processing B) will be executed. In the processing, a portion (approval column) to which the approval of the User 4 is to be recorded is found in the document, and then the approval seal of the User 4 is put on the portion.

(6) Transmitting to the User 5

The document approved by the User 4 will be transmitted from the box 151 to the input/output terminal (personal computer: PC) of the user 5.

Furthermore, in order to cope with the fact that the purpose of printing the document in the box 151 changes depending on the operation stage, the print mode corresponding to the operation stage (document processing stage) is automatically applied.

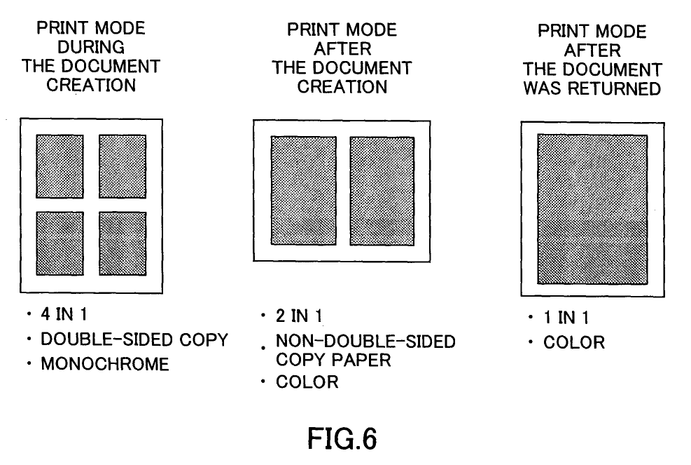

FIG. 6 shows examples of print modes set depending on the document processing stage.

In this examples, during the document creation, the print mode of “4 in 1, double-sided copy, monochrome” is set. After the document creation, the print mode of “2 in 1, non-double-sided copy, color” is set. Further, after returning the document, the print mode of “1 in 1, color” is set.

(Registration of Contents of Document Processing)

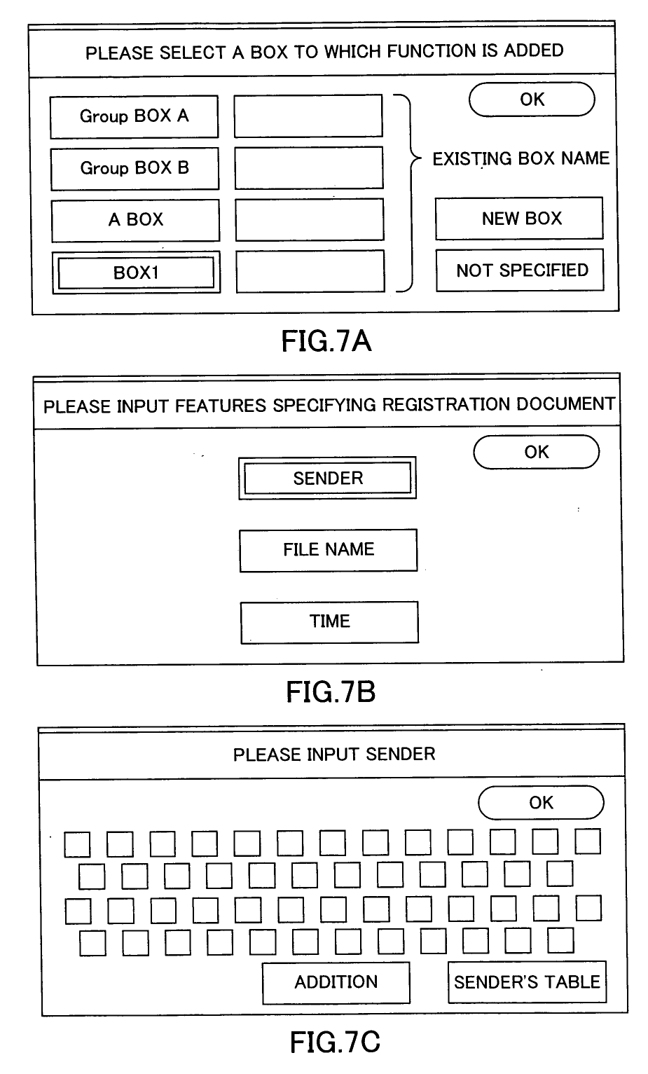

The following explanation will be directed to the registration operation for registering the contents of document processing made by a user in order to execute the aforementioned document processing. The registration of the contents of document processing is to be performed prior to the aforementioned sequence of operations (1) to (6). FIGS. 7 to 9 illustrate an example of a screen of the operation panel 13 for setting document processing functions in the box 151.

Initially, a user specifies one of the boxes in which certain document processing is to be performed, i.e., a new box function is to be set. FIG. 7A illustrates a screen for selecting a box in which the document processing is executed. A user can select one of the displayed existing boxes or create a new box by the new box button.

After specifying one of the boxes, the user selects a feature for specifying a document to be registered (hereinafter “registration document”) in the box. FIG. 7B illustrates an input screen for specifying a registration document. In the document processing apparatus 1 according to this embodiment, as features for specifying a registration document, “sender,” “file name,” “time” can be selected among selectable items.

After the selection of the “sender” as a feature specifying a registration document, the concrete sender is input. “Sender” denotes the information capable of specifying a sender. As the “sender,” an identification number of the sender and the address of the sender specifying the registration document can be exemplified. FIG. 7C illustrates an input screen for inputting the sender specifying the registration document. In cases where several senders have been registered in the document processing apparatus 1, one of the senders can be selected among the previously registered terminal lists which will be displayed by the “SENDER'S TABLE” button. In cases where a plurality of users 1 to 3 create their respective assigned parts of a document, the second sender and senders subsequent thereof (or second input/output terminals 2 and input/output terminals subsequent thereof) can be input in turn by using the “ADDITION” button.

Subsequently, the contents of document processing, which will be executed when all of the documents created by the users 1 to 3 are registered (gathered), are set.

In this document processing apparatus according to this embodiment, in cases where a plurality of documents are to be processed, in the document processing, these documents are arranged in the correct order while referring the chapter number in each document and then combined into a single document.

The following explanation will be directed to a setting of document processing (image processing A) for changing the date contained in each document constituting the combined document.

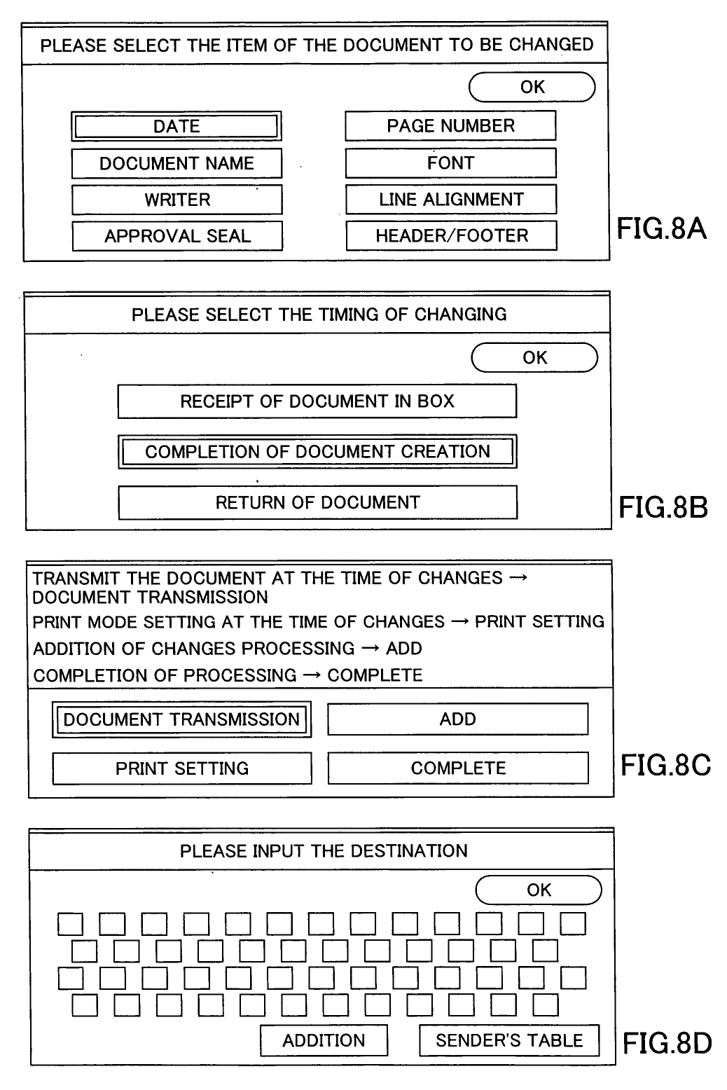

Initially, a user specifies the portion of each document to be changed among the contents of the document. FIG. 8A illustrates a selection screen for selecting the portion to be changed. In the document processing apparatus 1 according to this embodiment, as a portion to be changed, a plurality of items are previously prepared. These items include “DATE, “DOCUMENT NAME,” “CREATOR,” “APPROVAL SEAL,” “PAGE NUMBER,” “FONT,” “LINE ARRANGEMENT,” “FOOTER/HEADER.” In this case, “DATE” is selected.

After selecting the portion to be change, the user sets the timing of changing the document contents. FIG. 8B illustrates a timing selection screen for selecting the timing of changing the document contents. In the document processing apparatus 1 according to this embodiment, as the timing of document processing, one of the previously prepared timings among “RECEIPT OF DOCUMENT IN BOX,” “COMPLETION OF DOCUMENT CREATION(ALL DOCUMENTS TO BE REGISTERED ARE AVAILABLE),” “RETURN OF DOCUMENT” can be selectable. In this case, “COMPLETION OF DOCUMENT CREATION” is selected.

After inputting the timing of changing the document contents, the user further selects whether another document processing is to be executed. FIG. 8C illustrates a document processing selection screen showing the state immediately after “DOCUMENT TRANSMISSION” button is pressed to select the document processing accompanied by changes of document contents. In this embodiment, “DOCUMENT TRANSMISSION” is selected to transmit the document to the user 4.

After the selection of the document transmission, a concrete destination is input. FIG. 8D illustrates an input screen for inputting a document destination. The user performs an input operation in the similar manner as shown in FIG. 7C. After the input of the destination, the screen returns to the screen shown in FIG. 8C when “OK” button is pressed.

In FIG. 8C, if “PRINT SETTING” is selected, a print mode to be applied when a print instruction is made by a user can be set in advance. This print mode is applied to the stage after the document processing which was set immediately before the screen shown in FIG. 8C.

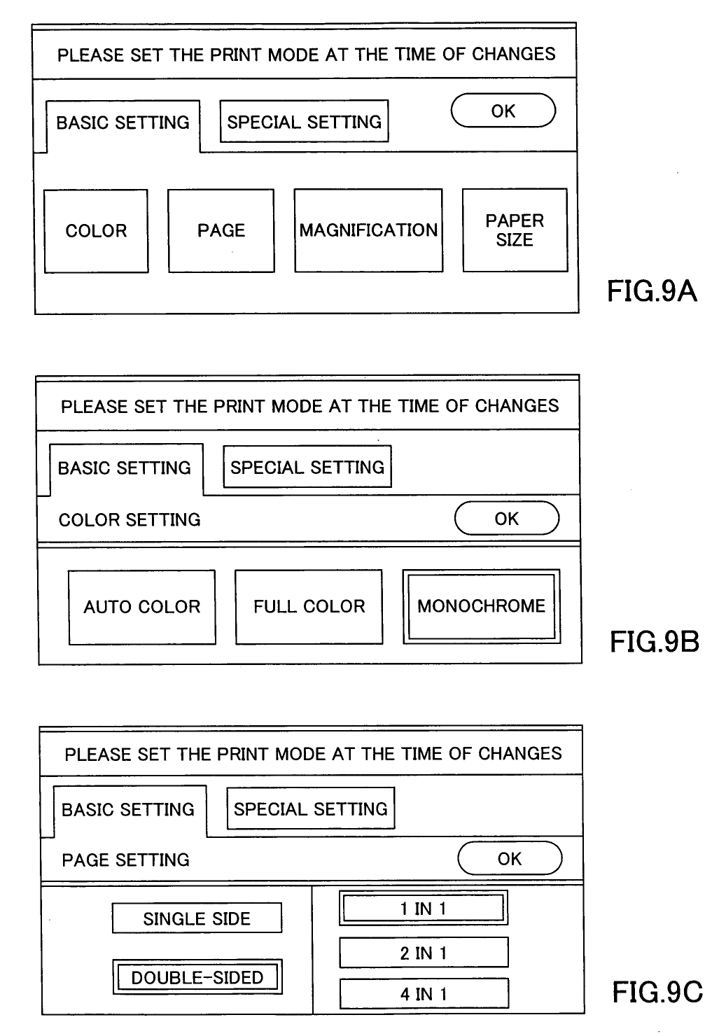

FIG. 9A illustrates a print mode setting screen for setting a print mode to be applied after the document processing accompanied by changes of document contents. In the document processing apparatus 1 according to this embodiment, one of the print modes including “COLOR,” “PAGE,” “MAGNIFICATION” and “PAPER SIZE” can be selected. If “COLOR” is selected as a print mode, the screen will be changed into a color mode setting screen shown in FIG. 9B. In this screen, one of the color modes including “AUTO COLOR,” “FULL COLOR” and “MONOCHROME” can be selected. If “PAGE” is selected in FIG. 9A, the screen will be changed into the page setting screen shown in FIG. 9C. In this screen, one of the layout setting including “SINGLE SIDE,” “DOUBLE-SIDED,” “1 in 1,” “2 in 1” and “4 in 1” can be selected.

In FIG. 8C, if the document processing is to be accompanied by another document processing, “ADDITION” button is pressed. This makes the current screen change into the screen shown in FIG. 8A. For example, in cases of setting document processing (image processing B) for putting an approval seal when there is a reply from the user 4, “APPROVAL SEAL” is selected in the screen shown in FIG. 8A and then “RETURN OF DOCUMENT” is selected. In the screen shown in FIG. 8C, by selecting “PRINT SETTING,” it becomes possible to set the print mode after the document approval by the user 4 (after the return of the document).

After the completion of all of the document processing and the print mode, “COMPLETE” is selected in the screen shown in FIG. 8C.

By inputting the document processing contents via the operation panel 13 by a user, the document processing contents will be converted into program codes by the program registration portion 14 and registered as the processing information of the box 151 specified by a user. Furthermore, the print mode corresponding to the stage of each processing inputted by a user is also registered as the print mode information of the box 151 by the program registration portion 14. FIGS. 2B and 2C show examples of processing information and print mode information to be registered as mentioned above.

(Document Processing Procedures)

A series of document processing procedures according to the aforementioned concrete example in the document processing apparatus 1 in which document processing contents to be executed in the box 151 is registered will be explained as follows.

<Document Processing Procedures at the Time of Receiving a Document>

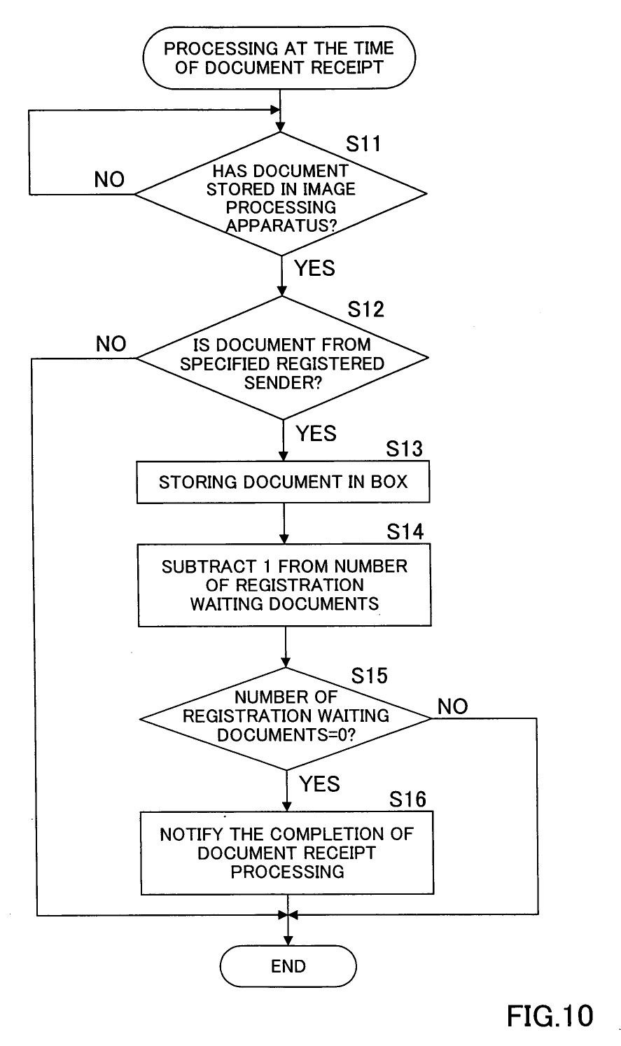

FIG. 10 is a flowchart showing an example of the processing procedures at the time of receiving a document by the image processing apparatus 1.

The processing procedures at the time of document receipt are as follows.

Initially, a document to be registered in a box 151 is transmitted from any one of the input/output terminals 2 (personal computers) to the document processing apparatus 1. This transmission includes a document registration instruction specifying a box 151 to be registered from the screen including the box list and the contents of the document to be registered.

In the document processing apparatus 1 received the aforementioned transmission, the operation controlling portion 11 makes the program executing portion 16 execute the programs including the processing contents which meet the execution conditions among programs registered in the box 151. Here, in order to meet the execution conditions that the document processing apparatus 1 received the document, a program including the processing contents associated with the execution conditions is executed.

The program executing portion 16 monitors the document registration operation until the registration of the document to the image processing apparatus 1 is completed (No at Step S11).

When the registration of the document is completed (Yes at Step S11), the program executing portion 16 discriminates whether the document is transmitted from the specified register (specified sender) (Step S12). If the document is not from the specified register (No at Step S12), the document processing is terminated.

If the document is from the specified register (Yes at Step S12), the program executing portion 16 stores this document in the box 151 (Step S13) and subtracts one from the number of registration waiting documents (Step S14). The number of registration waiting documents denotes a counter which discriminates whether all of the documents from the specified registers are gathered. In this embodiment, since it is set that the documents from three users are registered, the initial entry is three. The number of registration waiting documents is stored in this box together with another information.

Since the aforementioned users 1 to 3 are the specified registers (senders), the documents received from these users 1 to 3 will be registered in turn as a registered document in the box 151.

Subsequently, the program executing portion 16 discriminates whether the number of registration waiting documents becomes zero “0” (Step S15). If the number is not zero (No at Step S15), since all of the documents to be registered are not gathered, this document receiving processing is terminated.

If the number of registration waiting documents is zero (Yes at Step S15), since documents to be registered, i.e., all of the documents from the users 1 to 3, are gathered, the completion of the document registration processing is notified (Step S16). Then, this document receiving processing is terminated.

The notice of the completion of the document registration processing will be made to the program executing portion 16 itself. By this, the document processing program at the time of document registration completion meeting the execution conditions will be executed.

<Document Processing Procedures at the Time of Completion of Document Registration>

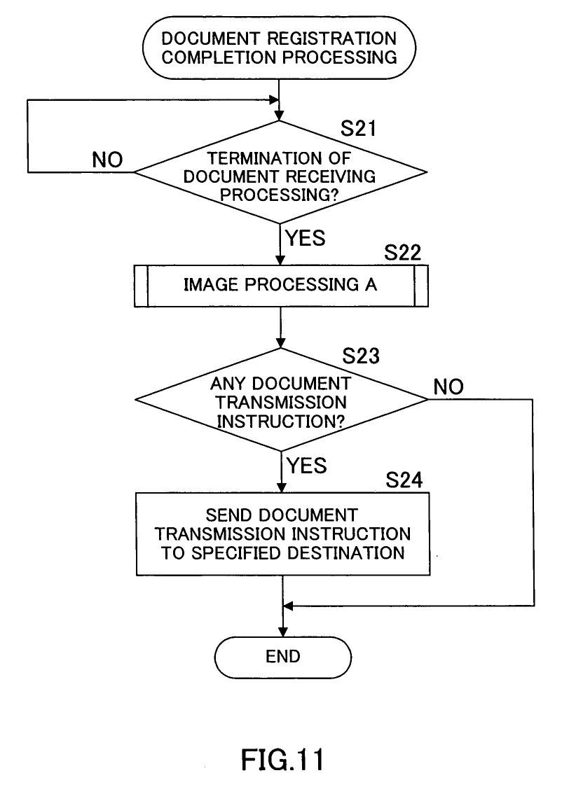

FIG. 11 is a flowchart showing an example of processing procedures at the time of the completion of the document registration.

The program executing portion 16 confirms the completion of the document registration processing to the box 151 (Yes at Step S21), and then makes the image processing portion 147 execute the image processing A for changing the document contents of the document in the box 151 (Step S22).

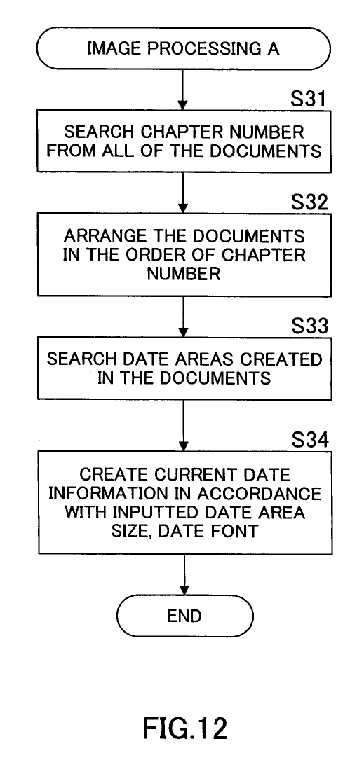

FIG. 12 is a flowchart showing an example of the procedures of the document processing (image processing A) accompanied by document contents changes which will be executed at the completion of the document registration.

The image processing portion 17 initially conducts a search for chapter numbers from all of the documents in the box 151 (Step S31) in accordance with the processing information (program) registered in the box 151. All of the documents in the box 151 denote the documents created by users 1 to 3. The aforementioned chapter number can be used to discriminate the order of documents assigned to the users 1 to 3, and is included in the document data as the document contents in each document. The image processing portion 17 searches the document contents to find out the portions where the chapter number is described, and specifies that the document created by the respective users 1 to 3 includes which chapter.

In the example shown in FIG. 4, the document created by the user 1 is Chapter 2, the document created by the user 2 is Chapter 3 and the document created by the user 3 is Chapter 1.

After the discrimination of Chapter of each document, the image processing portion 17 executes the document processing for arranging the documents in the order of Chapter based on the discrimination result (Step S32). These documents arranged in the order of Chapter will be combined into a single document (document file).

Subsequently, the image processing portion 17 searches the data area created in the document (Step S33). The date area denotes an area in which the creation date is described in each document created by each user 1 to 3, and is included in the combined document.

In the example shown in FIG. 4, “Sep. 1, 2002” is described in the document (Chapter 2) created by the user 1, “Sep. 8, 2002” is described in the document (Chapter 3) created by the user 2, and “Sep. 3, 2002” is described in the document (Chapter 1) created by the user 3.

The image processing portion 17 executes the document processing for overwriting the current date in each date area found in each document in accordance with the inputted date area scale, date font, etc. (Step S34). This document processing is the document processing (image processing) accompanied by document contents changes. By this step, when the documents of the users 1 to 3 are gathered, i.e., when the combination of the documents is completed, the date is written in the combined document.

Thus, the image processing A by the image processing portion 17 is terminated, and then transferred to the program executing portion 16. The routine returns to the flow shown in FIG. 11.

Subsequently, the program executing portion 16 discriminates whether there is an instruction (program) for transmitting the document to which the document processing (image processing A) was executed to be accompanied by document contents changes (Step S23).

If there is no transmission instruction (No at Step S23), the program executing portion 16 terminates the processing at the time of completion of the document registration as it is.

If there is a transmission instruction (Yes at Step S23), the program execution portion 16 sends a document transmission instruction to the network interface portion 12 for transmitting this document to the specified destination (Step S24), and terminates the processing at the time of completion of the document registration. In this example, the specified destination is the user 4.

The network interface portion 12 received the transmission instruction transmits the document to the specified destination (user 4).

<Document Processing Procedures at the Time of Returning the Document>

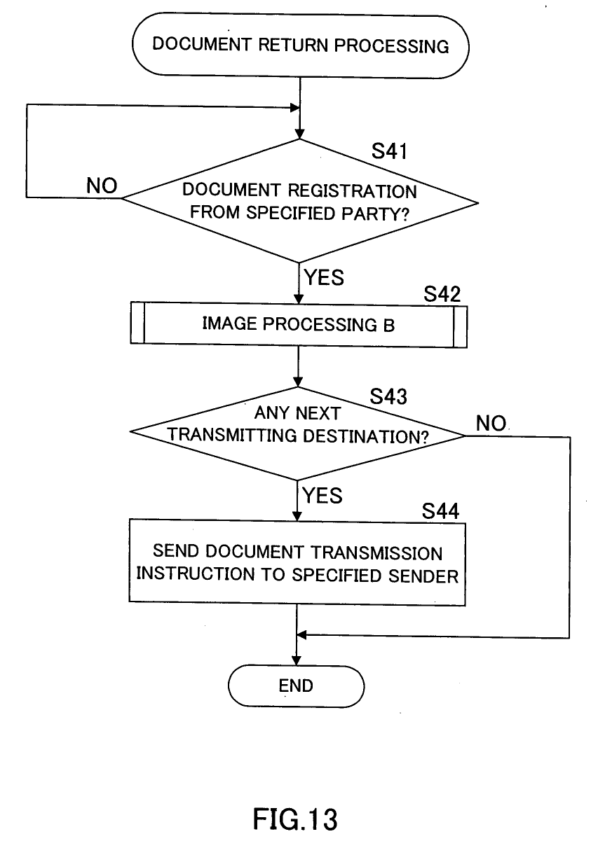

FIG. 13 is a flowchart showing an example of the processing procedures to be executed after the returning of the document from the specified destination (other party).

In the processing procedures, the document is returned from the specified destination (other party) to the document processing apparatus 1. Attached to this return document are the information proving the return document and the information specifying the box to receive the return document. Since the execution conditions at the time of returning the document among the processing information specifying the box to receive the return document, the operation controlling portion 11 makes the program executing portion 16 execute the processing contents (program) associated with the execution conditions.

After confirming the completion of the registration processing of the return document in the box 151 (Yes at Step S41), the program executing portion 16 makes the image processing portion 17 execute the image processing B for changing the document contents of the document (return document) in the box 151 (Step S42).

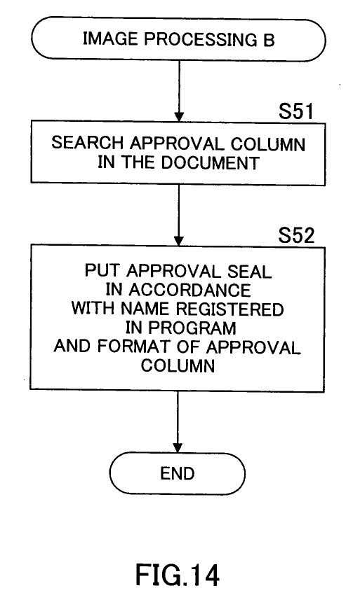

FIG. 14 is a flowchart showing an example of the procedures of the document processing (image processing B) accompanied by document contents changes, which is performed when the approved document is returned.

The image processing portion 17 searches the approval column in the document stored in the box 151 in accordance with the processing information (program) registered in the box 151 (Step S51). The aforementioned document stored in the box 151 means the document returned from the user 4, i.e., the document approved by the user 4. The aforementioned approval column is previously created in the document data as document contents by the respective users 1 to 3 so that the column can be used to obtain the approval of the user 4.

In the example shown in FIG. 5, an approval column is created on the sheet entitled “oo specification.”

The image processing portion 17 puts an approval stamp, which consists of the name of reply person (the name of the user 4) registered in the processing contents (program) in the box, on the approval column in accordance with the format of the approval column (Step S52). This document processing is document processing (image processing) accompanied by document contents changes. This document processing enables the users to confirm that the documents created by the users 1 to 3 are approved by the user 4 from the document contents.

Then, the image processing B by the image processing portion 17 is terminated, and will be transferred to the program executing portion 16. The routine returns to the flow shown in FIG. 13.

The program executing portion 16 discriminates whether there is an instruction (program) for transmitting the document to which the document processing (image processing B) accompanied by document contents changes (Step S43) was executed.

If it is discriminated that there is no transmission instruction (No at Step S43), the program executing portion 16 terminates the processing at the time of returning the document.

If it is discriminated that there is a transmission instruction (Yes at Step S43), the program executing portion 16 sends a document transmission instruction to the network interface portion 12 to transmit the document to the specified next destination (Step S44), and terminates the processing at the time of returning the document. In this embodiment, the aforementioned specified next destination is the user 5.

<Print Processing>

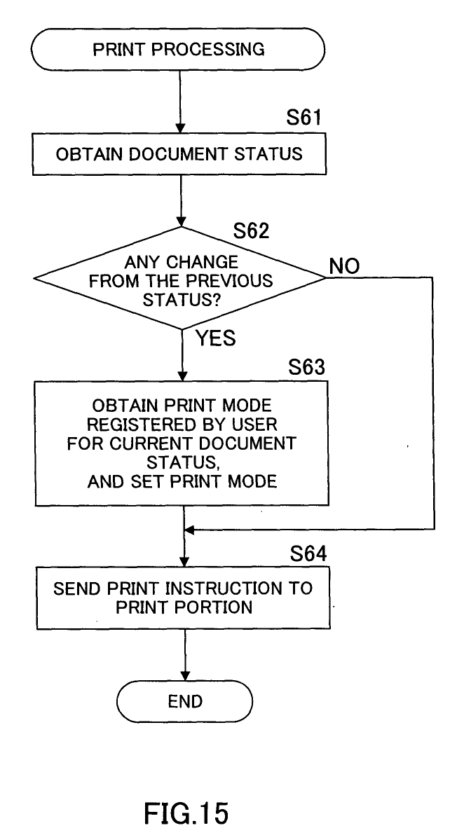

FIG. 15 is a flowchart showing an example of the processing procedures at the time of receiving a print instruction.

The print instruction can be given at various processing stages (document status) of the sequence of operation using the document in the box 151 by a users 1 to 5. The purpose of print differs depending on the processing stage.

In this processing procedure, a print instruction is given to the document processing apparatus 1 from any one of the users 1 to 5. This print instruction includes the information specifying the user issued the print instruction and the information specifying the document to be printed and the box including the document. The operation controlling portion 11 confirms the print instruction is issued by the user having an authority to print. Thereafter, since the executing conditions at the time of receiving the print instruction among the processing information of the box 151 according to this print information are met, the operation controlling portion 11 makes the program executing portion 16 execute the processing contents (program) associated with the executing condition.

The program executing portion 16 obtains the document status at the time of issuing the print instruction (Step S61). This document status can be discriminated based on which executing timing (executing condition) of the processing information (see FIG. 2B) of the box 151 is met and whether the corresponding document processing has been completed. Concretely, the discrimination can be performed by referring a flag or the like showing that each document processing was executed which was recorded in the box 151 or another recording means.

Subsequently, the program executing portion 16 discriminates whether the document status is changed since the print instruction was issued, or whether any other document processing is executed since the print instruction was issued (Step S62). This discrimination can be performed by comparing the document status at the time of the previous print instruction and registered in the box or another registering means with the current document status.

If there is no status change (No at Step S62), the program executing portion 16 sends a print execution instruction including the information specifying the document to be printed among the document information in the box 151 to the print portion 18 (Step S64). Then, the print portion 18 refers the document information in the box 151 and executes the print processing in the previously set print mode.

To the contrary, if there is a change in document status (Yes at Step S62), the program executing portion 16 refers the print mode information (See FIG. 2C) in the box 151, obtains the contents of the print mode registered by the user depending on the current document status. Then, the program executing portion 16 changes the setting of the print mode (Step S63). Concretely, the program executing portion 16 creates the information specifying the contents of the print mode to be set among the print mode information.

Then, the program executing portion 16 sends the print execution instruction including the information specifying the document to be printed among the document information in the box 151 to the print portion 18 (Step S64). In this case, the print execute instruction includes the information specifying the contents of the aforementioned print mode. Then, the print portion 18 changes the print mode information by referring the document information in the box 151, and then executes the print processing while referring the document information in the box 151.

In the aforementioned embodiment, in cases where the print instruction is issued at the stage before the completion of the document registration, i.e., during any one of the users 1 to 3 is being creating the document (see “Document is being creating” in FIG. 2C), the print mode of “4 in 1, double-sided copy, Monochrome” has been set by the user because of the following reasons. Most of the print at this timing is performed to confirm the contents of the document which is being created, and therefore the printing is required to be performed at low cost.

In cases where the print instruction is issued at the stage after the completion of the document registration and before the document return, i.e., the user 4 has not approved the completed document yet (see “After the document creation” in FIG. 2C), the print mode of “2 in 1, non-double-sided paper, color” has been set by the user because of the following reasons. At this timing, it is assumed that the printing will be performed to confirm the document contents by the user 4, and therefore it is required to provide the printed document capable of grasping the contents while keeping down the cost.

In cases where the print instruction is issued at the stage after the document return, i.e., the approval by the user 4 (see, “After the document approval” in FIG. 2C), the print mode of “1 in 1, color” has been set by the user because of the following reasons. At this stage, the printed document will be utilized for serious purposes of the document such as providing it to a client.

(Effects of the Embodiment)

According to the document processing apparatus, by setting the document processing contents for changing the contents of the document in the box together with the execution conditions by a user, the document processing for changing the document contents will be automatically executed when the executing conditions are met. Accordingly, if a user creates a document and registers it in a box, various document processing (editing, revising, approving, circulating) accompanied by document contents changing processing depending on the user's needs can be performed automatically and correctly without trouble.

Accordingly, the document processing apparatus can cope with such request that “in cases where a plurality of users take charge of creating respective parts of a document, a common date is printed on each part of the document” without imposing a burden on the users.

In other words, according to a conventional box function, to cope with the aforementioned request, it was required for a user to confirm that all of the documents were gathered in the box and the date of the documents had to be changed manually. However, in the aforementioned document processing apparatus according to the embodiment, it is possible to release the user from the burden.

Furthermore, the document processing apparatus can cope with such request that “in cases where the document is sent around to a plurality of users, the information showing that the document was sent around to the users is printed on the document” without imposing a burden on the user.

In other words, according to a conventional box function, to cope with the aforementioned request, it was required for a user accessed to or administering the document to open the document with an apparatus such as a computer equipped with a document editing function and a software and then save the document after adding an approving seal. However, in the aforementioned document processing apparatus according to the embodiment, it is possible to eliminate the burden of the user.

The timing of document processing to the documents in the box is not limited to the timing before or after the document is registered, and can be set arbitrarily. Accordingly, the document processing apparatus can be easily applied to various purposes.

Furthermore, according to the aforementioned document processing apparatus, by setting print modes each depending on the stage (document status) of the processing of the document in the box by the user in advance, when a print instruction is issued, an appropriate print mode depending on the timing is set automatically, and the print processing will be executed. Accordingly, the user can obtain a printed document appropriate to the purpose by simply instruct the printing without considering the print mode settings.

Accordingly, in cases where the purpose of the printing of the documents changes as the processing of the documents in the box advances, an appropriate print mode corresponding to the stage of the document processing can be set automatically without manually setting the print mode when the user sends the print instruction, resulting in a reduced burden of the user and enhanced convenience.

Furthermore, it is possible to avoid to print the document in unnecessary high quality print mode, which enables a reduction of the running cost.

Although an embodiment of the present invention is explained, the present invention can be modified as follows.

(a) Although in the aforementioned embodiment the contents of the document processing of the document in the box is registered in the box, the contents can be registered in another registering means in such a manner that the contents are correlated with the box. Furthermore, although in the aforementioned embodiment the contents of the print mode to be applied to the document in the box are registered in the box, the contents can be registered in another registering means in such a manner that the contents are correlated with the box.

(b) Although in the aforementioned embodiment the document received from the input/output terminal (personal computer) via the network 3 is exemplified as the document to be subjected to the document processing in the box, it is not limited to this example. For instance, the document can be a facsimile document received from an external facsimile apparatus via a telephone circuit, an electronic mail document or a document obtained by a scanner function equipped with the document processing apparatus 1 itself.

(c) Although in the aforementioned embodiment the document processing apparatus 1 is provided with the print portion, the apparatus can be an apparatus having no print portion and connected to an external printer via a network or the like.

(d) Although in the aforementioned embodiment a plurality of documents created by respective users are combined into a single document and this document is subjected to the document processing, the document processing can be subjected to a single document created without being combined.

(e) Although in the aforementioned embodiment the contents of the document processing and the print mode setting are inputted via the operation panel of the document processing apparatus, various inputs can be performed by external input/output apparatuses (personal computers) connected to a network. In this case, the network interface portion functions as a processing contents input means to receive various documents processing contents to be executed against the document in the box from a user.

(f) Although in the aforementioned embodiment, regarding the contents of the document processing of the document in the box, the execution conditions of the document processing (executing timing), the contents of the print modes and the conditions to be applied to each print mode (stage of processing; document status), previously prepared selections are presented on the operation panel for the user, a user can directly input a program to execute the contents of the document processing by using program language.

(g) Although in the aforementioned embodiment the execution conditions of the document processing is capable of being set by a user, one or a plurality of execution conditions can be set in advance.

(h) Although in the aforementioned embodiment after setting the contents of the document processing (FIG. 8A) the execution conditions are set (FIG. 8B), the execution conditions can be set before the setting. Furthermore, in cases of proposing a plurality of selections, items not to be selected can be displayed with gray color so that they cannot be selected. As such a item, “Document return” item in FIG. 8B which is to be performed before the setting of the document transfer processing can be exemplified.

(i) The aforementioned embodiment is based on the assumption that the box for registering the document exists at the time of receiving the document by the document processing apparatus. However, in cases where no specified box exists, the operation controlling portion can execute processing for creating a new box in the recording portion and registering the document therein, processing for registering the document as a general document, processing for transmitting the message that the document sender (user) has no box, or processing for making the sender (user) of the document select from alternative options.

Furthermore, even if there exists a box, in cases where the document is not a document sent from the specified registered sender (specified sender) (No at Step S12), processing for creating a new box in the operation controlling portion or processing for transmitting such a message to the sender (user) of the document can be executed.

(j) Although in the aforementioned embodiment various print modes are applied automatically by setting a print mode corresponding to the processing stage of the document by a user, various print modes which will be automatically applied depending on the stage of the document processing can be set in advance. For example, if one or a plurality of procedures are prepared in advance, an appropriate print mode depending on the document processing procedure can be set in advance.

(k) Although in the aforementioned embodiment, in cases where document processing (image processing) accompanied by document contents changes is executed, the print mode is changed by considering that the stage of the document processing is changed before or after the document processing. However, the print mode can be changed before or after the document processing not accompanied by image processing or before or after that a predetermined conditions (for example: before or after a predetermined time has passed since a document registration) are met though concrete image processing will not be-executed.

(i) Although in the aforementioned embodiment the print mode is changed depending the timing of the print instruction, in addition to that, the print mode change can be performed while considering who sent the print instruction. In this case, the apparatus can be appropriately cope with the cases even if the purposes of the print are different between the case where the print instruction is from the document creator and the case where the print instruction is from another person.

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

What is claimed is:

1. A document processing apparatus, comprising:
a box capable of storing a document;
a processing contents input unit which receives contents of document processing for changing document contents of the document stored in said box;
a processing contents storage unit which stores the contents of document processing, said processing contents storage unit being provided within or outside said box; and
a document contents change processing unit which executes document processing for changing the document contents of the document stored in said box based on the contents of document processing when prescribed execution conditions to execute the document processing are met.

2. The document processing apparatus as recited in claim 1, wherein, said execution conditions are at least one of execution conditions including: a) the document is received from a previously specified transmitting source; b) a plurality of previously specified documents are stored in said box; c) the change of document contents of the document in said box has been completed; and d) a previously set time has been passed.

3. The document processing apparatus as recited in claim 1, wherein at least one of document administrative information including a document creation date, a document file name, an issuance department, an approval seal section and a document number can be set as the document contents of the document to be changed.

4. The document processing apparatus as recited in claim 1, wherein said processing contents input unit receives the contents of the document processing and execution conditions for executing the document processing, and wherein said processing contents storage unit stores the contents of the document processing and the execution conditions.

5. The document processing apparatus as recited in claim 1, wherein said processing contents input unit selectively presents a plurality of execution conditions to execute the document processing to a user.

6. The document processing apparatus as recited in claim 1, wherein the execution conditions are that a previously set certain number of documents is stored in said box.

7. The document processing apparatus as recited in claim 1, wherein said processing contents storage unit is capable of storing contents of a plurality of documents in any one of said box.

8. The document processing apparatus as recited in claim 1, wherein said processing contents input unit presents contents of a plurality of the document processing to a user in a selectable manner.

9. The document processing apparatus as recited in claim 1, wherein said document processing apparatus is provided with a plurality of boxes capable of storing a document, and wherein said processing contents input unit receives contents of the document processing of the document stored in any one of said plurality of boxes from a user.

10. The document processing apparatus as recited in claim 1, wherein a plurality of documents are stored in said box, and wherein said processing contents input unit receives the contents of the document processing for any one of the documents in said box.

11. A document processing apparatus, comprising:
a box capable of storing a document;
a document processing unit which executes a prescribed document processing for the document in said box when prescribed conditions are met;
a print mode storage unit which stores a stage of the prescribed document processing and a print mode in an associated manner;
a print instruction input unit which receives a print instruction for the document in said box from a user; and
a print mode control unit which changes the print mode into a print mode associated with a stage of the document processing depending on the document processing at the time of receiving the print instruction.

12. The document processing apparatus as recited in claim 11, wherein the print mode to be changed is capable of being set at least one of a paper type, a paper property, a paper size, a layout and a color mode.

13. The document processing apparatus as recited in claim 11, wherein said print mode storage unit is capable of storing contents of a plurality of print modes in said box.

14. The document processing apparatus as recited in claim 11, further comprising a print mode input unit which receives contents of the print mode at each stage of the document processing.

15. The document processing apparatus as recited in claim 14, wherein said print mode input unit receives the contents of the print mode and the stage of the document processing associated with the print mode from a user.

16. The document processing apparatus as recited in claim 14, wherein said print mode input unit presents the stage of the plurality of document processing to a user in a selectable manner.

17. The document processing apparatus as recited in claim 14, wherein said print mode input unit presents the contents of the plurality of print modes to a user in a selectable manner.

18. The document processing apparatus as recited in claim 14, wherein said document processing apparatus is provided with a plurality of boxes capable of storing a document, and wherein said processing contents input unit receives contents of the document processing of the document stored in any one of said plurality of boxes from a user.

19. The document processing apparatus as recited in claim 14, wherein each of said one or a plurality of box is capable of storing a plurality of documents, and wherein said processing contents input unit receives the contents of document processing for any one of documents in said each of said one or a plurality of box.

20. A document processing method, comprising steps of:
obtaining contents of document processing of a document capable of being stored in a box to be changed in advance;
storing the contents of the document processing;
executing the document processing to change the document contents based on the contents of the document processing of the document stored in said box when prescribed conditions of the document processing are met.

21. A document processing method in a document processing apparatus to execute a prescribed document processing when prescribed conditions are met for a document in a box capable of storing a document, the document processing method, comprising steps of:
storing the stage of the document processing and a print mode in an associated manner in advance;
changing the print mode into a print mode associated with the stage of the document processing depending on the stage of the document processing when a print instruction for printing a document in said box from a user.

22. A computer readable recording medium in which a program functioning a computer as a document processing apparatus is stored, wherein said program functions the computer as
a box capable of storing a document;
a processing contents input unit which receives contents of document processing for changing a document contents of the document stored in said box;
a processing contents storage unit which stores the contents of document processing, said processing contents storage unit being provided within or outside said box; and
a document contents change processing unit which executes document processing for changing the document contents of the document stored in said box based on the contents of document processing when prescribed execution conditions to execute the document processing are met.

23. A computer readable recording medium in which a program functioning a computer as a document processing apparatus is stored, wherein said program functions the computer as
a box capable of storing a document;
a document processing unit which executes a prescribed document processing for the document in said box when prescribed conditions are met;
a print mode storage unit which stores a stage of the prescribed document processing and a print mode in an associated manner;
a print instruction input unit which receives a print instruction for the document in said box from a user; and
a print mode control unit which changes the print mode into a print mode associated with a stage of the document processing depending on the document processing at the time of receiving the print instructiong.
